(19) United States
(12) Patent Application Publication
(10) Pub. No.: US 2021/0317300 A1
(43) Pub. Date: Oct. 14, 2021

(54) Polyester Sheet

(71) Applicant: FAR EASTERN NEW CENTURY CORPORATION, Taipei City (TW)

(72) Inventors: Kuan-Liang Wei, Taipei City (TW); Shu-Chuan Liu, Taipei City (TW)

(21) Appl. No.: 17/001,814

(22) Filed: Aug. 25, 2020

(30) Foreign Application Priority Data
Apr. 8, 2020 (TW) 109111723

(51) Int. Cl. C08L 67/03; B32B 27/08; B32B 27/36; B32B 27/18

(52) U.S. Cl. CPC C08L 67/03; B32B 27/08; B32B 27/36; B32B 2250/40; B32B 2250/03; B32B 2250/244; B32B 2264/025; B32B 27/18

(57) ABSTRACT

A polyester sheet includes at least one modified layer made from a polyester composition including a polyester, a polyester-polyether copolymer, a slip agent which has a solubility parameter ranging from 17 MPa^{1/2} to 22 MPa^{1/2}, and an anti-blocking agent. Based on 100 parts by weight of the polyester, the polyester-polyether copolymer is present in an amount ranging from 0.5 part by weight to 5 parts by weight, the slip agent is present in an amount ranging from 0.02 part by weight to 0.5 part by weight, and the anti-blocking agent is present in an amount ranging from 0.05 part by weight to 0.6 part by weight.

### CROSS-REFERENCE TO RELATED APPLICATION

This application claims priority to Taiwanese Patent Application No. 109111723, filed Apr. 8, 2020, the disclosure of which is hereby incorporated by reference in its entirety.

### FIELD

This disclosure relates to a layered product made from a polymer composition, and more particularly to a polyester sheet made from a polyester composition.

### BACKGROUND

A conventional polyester sheet, which generally has a thickness of greater than 0.2 mm, is usually made of polyesters such as polyethylene terephthalate (PET) and polybutylene terephthalate (PBT) to provide a satisfactory transparency and printability for subsequent application as packaging boxes. During the manufacturing process of packaging boxes, 200 to 300 of the polyester sheets are stacked on one another and then cut to obtain cut products having desired sizes. The cut products are then subjected to additional manufacturing steps such as printing, patching, folding, and pasting, etc., to obtain the packaging boxes. The stacked polyester sheets are required to possess satisfactory cutting properties to prevent breakage and/or flash on the cut products so as to improve the efficiency and quality of such manufacturing steps. However, when the polyester sheets are stored or manufactured under a low temperature, such as during winter or in cold regions, the cutting properties thereof may be adversely affected.

For improving the cutting properties of polyester sheets, U.S. Pat. No. 8,574,694 B2 discloses a multilayer non-oriented thermoformable packaging sheet including a rigid component layer. The rigid component layer includes a blend of an aromatic polyester and a styrenic polymer, where the total amount of styrenic polymer present in the packaging sheet relative to the total weight of the packaging sheet is at least between 3.0% and 4.0% by weight. The packaging sheet has a normalized impact strength of 0.16 ft*lbf/mil or less total energy as measured in accordance with ASTM D3763-08 test method, which indicates the packaging sheet has good cutting properties. However, such patent document does not address the adverse effect of storing or manufacturing the packaging sheet under low temperature on the cutting properties thereof.

Therefore, there is still a need to develop a polyester film which is manufactured under low temperature for subsequent packaging, and which has improved cutting properties.

### SUMMARY

Therefore, an object of the disclosure is to provide a polyester sheet that can alleviate or eliminate at least one of the drawbacks of the prior art.

According to the disclosure, the polyester sheet includes at least one modified layer made from a polyester composition including a polyester, a polyester-polyether copolymer, a slip agent which has a solubility parameter ranging from 17 MPa^{1/2} to 22 MPa^{1/2}, and an anti-blocking agent. Based on 100 parts by weight of the polyester, the polyester-polyether copolymer is present in an amount ranging from 0.5 part by weight to 5 parts by weight, the slip agent is present in an amount ranging from 0.02 part by weight to 0.5 part by weight, and the anti-blocking agent is present in an amount ranging from 0.05 part by weight to 0.6 part by weight.

### DETAILED DESCRIPTION

For the purpose of this specification, it will be clearly understood that the word “comprising” means “including but not limited to”, and that the word “comprises” has a corresponding meaning.

Unless otherwise defined, all technical and scientific terms used herein have the meaning commonly understood by a person skilled in the art to which this disclosure belongs. One skilled in the art will recognize many methods and materials similar or equivalent to those described herein, which could be used in the practice of this disclosure. Indeed, this disclosure is in no way limited to the methods and materials described. For clarity, the following definitions are used herein.

As used herein, the term “room temperature” refers to a temperature that is greater than 10° C. and not higher than 45° C. The term “low temperature” refers to a temperature lower than the room temperature, such as −20° C. to 10° C.

This disclosure provides a polyester composition which includes a polyester, a polyester-polyether copolymer, a slip agent, and an anti-blocking agent. Based on 100 parts by weight of the polyester, the polyester-polyether copolymer is present in an amount ranging from 0.5 part by weight to 5 parts by weight, the slip agent is present in an amount ranging from 0.02 part by weight to 0.5 part by weight, and the anti-blocking agent is present in an amount ranging from 0.05 part by weight to 0.6 part by weight.

As used herein, the term “polyester” is understood to mean a synthetic polymeric product prepared by a polycondensation reaction of a diol and a dicarboxylic acid or of a diol and a dicarboxylic ester.

Examples of the diol may include, but are not limited to, ethylene glycol, 1,2-propylene glycol, 1,3-propylene glycol, diethylene glycol, neopentyl glycol, 1,3-butanediol, 1,4-butanediol, 1,5-pentanediol, 1,6-hexanediol, 2,2,4-trimethyl-1,6-hexanediol, 1,3-cyclohexanedimethanol, 1,4-cyclohexanedimethanol, and combinations thereof.

Examples of the dicarboxylic acid may include, but are not limited to, terephthalic acid, phthalic acid, 2,6-naphthalene dicarboxylic acid, 1,5-naphthalene dicarboxylic acid, and combinations thereof.

Examples of the dicarboxylic ester may include, but are not limited to, dimethyl terephthalate, dimethyl phthalate, dimethyl naphthalate-2,6-dicarboxylate, dimethyl naphthalate-1,5-dicarboxylate, and combinations thereof.

Examples of the polyester may include, but are not limited thereto, polyethylene terephthalate (PET), polybutylene terephthalate (PBT), polyethylene naphthalate (PEN), poly (ethylene terephthalate-1, 4-cyclohexylenedimethyl terephthalate) (PETG), and combinations thereof. In certain embodiments, the polyester is PET.

The polyester-polyether copolymer includes a polyester segment and a polyether segment. The polyester segment may be, for example, a PET segment or a PBT segment, but is not limited thereto. The polyether segment may be, for example, a polyethylene glycol (PEG) segment, or a poly (tetramethylene ether) glycol (PTMEG) segment, but is not limited thereto. In certain embodiments, the polyester segment is the PET segment. In other embodiments, the polyether segment is the PTMEG segment, which allows a polyester sheet made therefrom to exhibit an improved elasticity, a higher resistance to hydrolysis, and a higher resistance to low temperature, which may prevent breakage of the polyester sheet during a cutting process under low temperature. In certain embodiments, based on a total weight of the polyester-polyether copolymer, the polyether segment is present in an amount ranging from 5 wt % to 60 wt %. When the amount of the polyether segment is not less than 5 wt %, the polyester sheet made from the polyester composition of this disclosure may have satisfactory cutting properties under low temperature, a higher resistance to cold impact, a higher transparency, and an improved printability. When the amount of the polyether segment is not greater than 60 wt %, the polyester-polyether copolymer may have a higher compatibility with the polyester (i.e., PET), which may decrease a degree of haze of the polyester sheet.

The polyester-polyether copolymer may be obtained commercially or may be synthesized by using any technique well-known and commonly used by those skilled in the art. For example, the polyester-polyether copolymer may be synthesized by first subjecting a diol and a dicarboxylic acid to a transesterification reaction to obtain a polyester product, and then subjecting the polyester product and a polyether to a polycondensation reaction to obtain the polyester-polyether copolymer. The dicarboxylic acid may be, for example, terephthalic acid, phthalic acid, 2,6-naphthalene dicarboxylic acid, 1,5-naphthalene dicarboxylic acid, or combinations thereof, but is not limited thereto. The diol may be, for example, ethylene glycol, 1,3-propylene glycol, 1,4-butanediol, or combinations thereof, but is not limited thereto. The polyether may be, for example, PEG, PTMEG, or combinations thereof, but is not limited thereto.

In certain embodiments, the polyester-polyether copolymer includes the PET segment and the PTMEG segment, which is made by subjecting dimethyl terephthalate and ethylene glycol to an esterification reaction to obtain a PET product, followed by subjecting the PET product and PTMEG to a condensation reaction.

The slip agent may have a solubility parameter closer to that of the polyester, so as to improve the compatibility therebetween. In certain embodiments, the slip agent has a solubility parameter ranging from 17 MPa^{1/2} to 22 MPa^{1/2}, which may improve the cutting properties and transparency of the polyester sheet. The slip agent may be an amide-containing compound, which has a relatively high resistance to high temperature, and therefore is less likely to diffuse under high temperature during the processing steps. Examples of the amide-containing compound may include, but are not limited to, stearamide, stearyl erucamide, ethylene bis(erucamide), and combinations thereof.

In certain embodiments, the anti-blocking agent may include inorganic particles and/or organic particles. Examples of the inorganic particles may include, but are not limited to, silicon oxide, calcium carbonate, aluminum silicate, barium sulfate, calcium phosphate, talcum, titanium oxide, aluminum oxide, calcium silicate, and combinations thereof. Examples of the organic particles may include, but are not limited to, a cross-linked methyl methacrylate-styrene copolymer, a cross-linked styrene copolymer, a cross-linked methyl methacrylate copolymer, and combinations thereof.

An average particle size of the anti-blocking agent is not particularly restricted, and may be selected based on a desired thickness of the polyester sheet to be made. For example, in certain embodiments, where the polyester sheet to be made is set to have a thickness ranging from 0.2 mm to 3.0 mm, the anti-blocking agent may have an average particle size ranging from 1 μm to 30 μm. When the average particle size of the anti-blocking agent is smaller than 1 μm, the polyester sheet may have an exceedingly smooth surface, and therefore may have a poor anti-blocking property. When the average particle size of the anti-blocking agent is greater than 30 μm, the polyester sheet may have an exceedingly rough surface, which may adversely affect the appearance of the polyester sheet.

According to the disclosure, the polyester sheet includes at least one modified layer made from the polyester composition as mentioned above. The polyester sheet may have a thickness of at least 0.2 mm, but is not limited thereto. In an exemplary embodiment, the polyester sheet includes one modified layer, which may be made by extruding the polyester composition using a single layer film extruder under an extrusion temperature of, for example, 200° C. to 300° C., but is not limited thereto.

In another exemplary embodiment, the polyester sheet includes two of the modified layers and a middle layer which includes a polyester, and which is sandwiched between the modified layers. Such polyester sheet may be made by using any technique well-known and commonly used by those skilled in the art. For example, the polyester composition of this disclosure and a polyester may be co-extruded using a three-layer co-extruder at an extrusion temperature of, for example, 200° C. to 300° C., to form the modified layers and the middle layer.

The thickness of the modified layers is not particularly limited and may be optimized based on practical requirements. Since the polyester in the middle layer has a relatively high transparency, when the middle layer of the polyester sheet has an increased thickness, the polyester sheet may have a higher transparency. On the other hand, when the thickness of the modified layers in the polyester sheet increases, the cutting properties of the polyester sheet may be improved. Therefore, in order to achieve a balance between the transparency and the cutting properties of the polyester sheet, in certain embodiments, based on a total thickness of the polyester sheet, the thickness of the modified layers ranges from 2% to 30%.

The disclosure will be further described by way of the following examples. However, it should be understood that the following examples are solely intended for the purpose of illustration and should not be construed as limiting the disclosure in practice.

### EXAMPLES

### Preparative Example 1: polyester-polyether Copolymer

232 g of dimethyl terephthalate, 93 g of ethylene glycol, 230 g of PTMEG (purchased from Dalian Chemical; Model: PTG1000), and an adequate amount of a tetra n-butyl titanate reaction catalyst (purchased from Borica Co., Ltd; Model: Tytan TNBT) were added into a reactor, in which the dimethyl terephthalate and the ethylene glycol were subjected to a transesterification reaction under an atmospheric pressure and a reaction temperature of 230° C. for 5 hours to obtain a transesterification product. The methanol (77 g) produced during the transesterification reaction was removed via distillation. Next, an adequate amount of the tetra n-butyl titanate reaction catalyst was further added into the reactor under stirring. During the stirring, the reactor was subjected to vacuum evacuation until the pressure therein was lowered to 1 mmHg. Subsequently, the reaction temperature in the reactor was raised to 260° C. so as to proceed with a polycondensation reaction of the transesterification product and the PTMEG for 4 hours, thereby obtaining the polyester-polyether copolymer having a polyester segment and a polyether segment. After cooling, the polyester-polyether copolymer was granulated. Based on a total weight of the polyester-polyether copolymer, the polyether segment (i.e., the PTMEG segment) was present in an amount of 50 wt %.

### Preparation of Polyester Sheet

### Example 1 (EX1)

A polyethylene terephthalate chips (Manufacturer: Far Eastern New Century Corporation; Model: CB600H, hereinafter abbreviated as PET chip) was placed in an oven and dried at a temperature of 140° C. for 12 hours. Next, 100 parts by weight of the PET chips, 0.35 part by weight of a cross-linked methyl methacrylate-styrene copolymer (purchased from Guidewin Special Chemical Co., Ltd; Model: GMS-5061; average particle size: 6 μm, hereinafter abbreviated as “A1”), which served as the anti-blocking agent, 0.075 part by weight of stearyl erucamide (purchased from Fine Organics; Model: Finewax SE; solubility parameter: 18 MPa^{1/2}, hereinafter abbreviated as “B1”), which served as the slip agent, and 2 parts by weight of the polyester-polyether copolymer obtained in Preparative Example 1 (hereinafter abbreviated as “C1”) were evenly mixed to obtain the polyester composition.

The polyester composition was then fed into a multi-layer sheet extrusion machine (Manufacturer: Leader Extrusion Machinery Ind. Co., Ltd), followed by melting and co-extruding the PET chips and the polyester composition at a heating temperature of 270° C. to obtain a polyester sheet having a three-layered structure and a thickness of 0.3 mm. The three-layered structure of the polyester sheet includes two modified layers made from the polyester composition of EX1, and a middle layer made of the PET chips, which is interposed between the modified layers. The modified layers have a total thickness of 0.036 mm (i.e., 12% of the thickness of the polyester sheet). The middle layer has a thickness of 0.264 mm (i.e., 88% of the thickness of the polyester sheet).

### Examples 2 to 4 and Comparative Examples 1 to 9 (EX2 to EX4 and CE1 to CE9)

The procedures and conditions for preparing the polyester sheets of EX2 to EX4 and CE1 to CE9 were similar to those of EX1, except that the amounts and/or types of the polyester, the polyester-polyether copolymer, the slip agent, and/or the anti-blocking agent in the polyester composition for each of the polyester sheets of EX2 to EX4 and CE1 to CE9 were varied as shown in Tables 1 to 3 below. It can be noted that, the anti-blocking agent of the polyester composition of EX2 is silicon dioxide (purchased from Sunsphere; Model: NP-30; average particle size: 4 μm, hereinafter abbreviated as “A2”). The slip agent of the polyester composition of EX4 is ethylene bis(erucamide) (purchased from Chin Yee Chemical Industries Co., Ltd; Model: EBO, hereinafter abbreviated as “B2”), which has a solubility parameter of 21 MPa^{1/2}. The slip agent of the polyester composition of EX6 is polyethylene wax (purchased from Clariant Specialty Chemicals; Model: LICOWAX PRE520, hereinafter abbreviated as “B3”), which has a solubility parameter f 16.2 MPa^{1/2}. In the polyester composition of CE9, the polyester-polyether copolymer used in EX1 is replaced with styrene-butadiene copolymer (purchased from NEOS Styrolution; Model: 684D, hereinafter abbreviated as “C2”).

### Evaluations:

The polyester sheets of EX1 to EX4 and CE1 to CE9 were evaluated with the following tests. The results are presented in Tables 1 to 3.

### 1. Cutting Properties

Each of the polyester sheets of EX1 to EX4 and CE1 to CE9 was cut into multiple test samples, each having a size of 10 mm (width)×300 mm (length). 250 of the test samples were stacked on one another and tested for the cutting properties independently under room temperature and under low temperature.

For evaluation of cutting properties of the polyester sheet under room temperature, the length-sides of the stacked test samples were cut using a high-speed cutter (Manufacturer: Polar; Model: POLAR N 137), and then each of the test samples was observed whether or not breakage is present and/or flash is formed on the cut surface.

For evaluation of cutting properties of the polyester sheet under low temperature, the stacked test samples were frozen at a temperature of −10° C. for 48 hours, followed by cutting at the length-sides using the high-speed cutter. The breakage and the formation of flash on the cut surface were observed and recorded for each of the test samples.

The cutting property of a polyester sheet is determined as “very good” and symbolized by “⊚” in Tables 1 to 3 if all of the test samples were free from breakage and flush. The cutting property of a polyester sheet is determined as “good” and symbolized by “∘” if all of the test samples of the test samples were free from breakage, and for each of the test samples, the flush formation is only observed on a region of the cut surface that is not greater than 30% of a total surface area of each of the test samples. The cutting property of a polyester sheet is determined as “poor” and symbolized by “x” if breakage of any one of the test samples is present or when the flush formation is observed on a region of the cut surface that is greater than 30% of the total surface area of each of the test samples.

### 2. Cold Impact Resistance

Each of the polyester sheets of EX1 to EX4 and CE1 to CE9 was first cut under a room temperature of 25° C. to obtain 10 test samples, each having a size of 50.8 mm (width)×146.1 mm (length) and having a pattern that is parallel to the length-sides thereof. Then, each of the test samples was bent into a “U” shape with two width-sides thereof being overlapped with each other and being taped together. Next, all of the bent test samples were placed in a freezer at a temperature of −20° C. for 40 minutes, followed by a cold impact test using a cold impact tester (Manufacturer: Gotech Testing Machines Inc; Model: GT-7041-50) conducted according to the test methods of ASTM D1790 (published in 2014). A percentage of breakage of the test samples under low temperature was calculated based on the formula: n/10×100%, in which n represents the number of the test samples that is broken. The polyester sheet is considered to have a satisfactory cold impact resistance when the percentage of breakage of the test samples is lower than 50%.

### 3. Transparency

The haze (%) of each of the polyester sheets was measured according to ASTM D1003 (published in 2007). The polyester sheet is considered to have a satisfactory transparency when the haze thereof is not greater than 4.0%.

### 4. Printability

The printability of each of the polyester sheets was measured according to the test methods of DIN ISO 8296 (published in 2008). To be specific, the polyester sheet was drawn with an ink line of 100 mm using a dyne test pen having a predetermined surface tension, and then was observed whether or not 90% of an outline of the ink line had shrunk within 2 seconds. If the outline of the ink line had shrunk, then the abovementioned procedures were repeated using another dyne test pen having a surface tension that is one level lower than that of the dyne test pen previously used. The same procedures were repeated until the ink line stopped shrinking, and the surface tension of the dyne test pen used in the corresponding test is determined as the surface tension of the polyester sheet. The polyester sheet is considered to have a satisfactory printability when the surface tension thereof is at least 36 dyne/cm.

TABLE 1

| | | | EX | | CE | | |
|---|---|---|---|---|---|---|---|
| Polyester sheet (total thickness: 3 mm) | | | 1 | 2 | 1 | 2 | 3 |
| Modified | Thickness (mm) | | 0.036 | 0.036 | 0.036 | 0.036 | 0.036 |
| layers | PET | Amount | 100 | 100 | 100 | 100 | 100 |
| | | (parts by weight) | | | | | |
| | Anti-blocking | Type | A1 | A2 | — | — | A1 |
| | agent | Amount | 0.35 | 0.35 | — | — | 0.80 |
| | | (parts by weight) | | | | | |
| | Slip agent | Type | B1 | B1 | — | B1 | B1 |
| | | Amount | 0.075 | 0.075 | — | 0.075 | 0.075 |
| | | (parts by weight) | | | | | |
| | Polyester-polyether | Type | C1 | C1 | — | C1 | C1 |
| | copolymer | Amount | 2 | 2 | — | 2 | 2 |
| | | (parts by weight) | | | | | |
| Property | Cutting property | Room temperature | ⊚ | ⊚ | X | X | ⊚ |
| evaluations | | Low temperature | ◯ | ◯ | X | X | ◯ |
| | Printability | Surface tension | 36 | 36 | 38 | 38 | 36 |
| | | (dyne/cm) | | | | | |
| | Cold impact | Percentage of | 40 | 40 | 90 | 45 | 48 |
| | resistance | breakage (%) | | | | | |
| | Transparency | Haze (%) | 3.4 | 3.8 | 1.6 | 3.1 | 6.9 |

“—” means not applicable, “A1” refers to a cross-linked methyl methacrylate-styrene copolymer, “A2” refers to silicon dioxide, “B1” refers to stearyl erucamide, and “C1” refers to the polyester-polyether copolymer of Preparative Example 1.

As shown in Table 1, the polyester sheet of CE1, which is made from PET only (i.e., without the anti-blocking agent, the slip agent, and the polyester-polyether copolymer), exhibits unsatisfactory cutting property and a relatively low cold impact resistance. The polyester sheet of CE2, which is made from the polyester composition not including the anti-blocking agent, is prone to adherence when stacked on one another, and therefore exhibits unsatisfactory cutting properties. In addition, the polyester sheet of CE3, which is made from the polyester composition including the anti-blocking agent in an amount of greater than 0.6 part by weight, exhibits a relatively low transparency.

In comparison, the polyester sheets of EX1 and EX2, each of which is made from the polyester composition including the anti-blocking agent, the slip agent, and the polyester-polyether copolymer, with the anti-blocking agent present in an amount within the range of 0.05 part by weight to 0.6 part by weight, exhibit satisfactory cutting property, printability and transparency, and have an improved cold impact resistance.

TABLE 2

| | | | EX | | CE | | | |
|---|---|---|---|---|---|---|---|---|
| Polyester sheet (total thickness: 3 mm) | | | 3 | 4 | 1 | 4 | 5 | 6 |
| Modified | Thickness (nm) | | 0.036 | 0.036 | 0.036 | 0.036 | 0.036 | 0.036 |
| layers | PET | Amount | 100 | 100 | 100 | 100 | 100 | 100 |
| | | (parts by weight) | | | | | | |
| | Anti-blocking | Type | A1 | A1 | — | A1 | A1 | A1 |
| | agent | Amount | 0.35 | 0.35 | — | 0.35 | 0.35 | 0.35 |
| | | (parts by weight) | | | | | | |
| | Slip agent | Type | B1 | B2 | — | — | B1 | B3 |
| | | Amount | 0.2 | 0.2 | — | — | 0.6 | 0.2 |
| | | (parts by weight) | | | | | | |
| | Polyester-polyether | Type | C1 | C1 | — | C1 | C1 | C1 |
| | copolymer | Amount | 2 | 2 | — | 2 | 2 | 2 |
| | | (parts by weight) | | | | | | |
| Property | Cutting property | Room temperature | ⊚ | ⊚ | X | X | ⊚ | ⊚ |
| evaluations | | Low temperature | ◯ | ◯ | X | X | ◯ | ◯ |
| | Printability | Surface tension | 36 | 36 | 38 | 38 | 30 | 30 |
| | | (dyne/cm) | | | | | | |
| | Cold impact | Percentage of | 37 | 40 | 90 | 45 | 35 | 45 |
| | resistance | breakage (%) | | | | | | |
| | Transparency | Haze (%) | 3.6 | 3.6 | 1.6 | 2.4 | 4.2 | 8.7 |

“—” means not applicable, “A1” refers to a cross-linked methyl methacrylate-styrene copolymer, “B1” refers to stearyl erucamide, “B2” refers to ethylene bis(erucamide), “B3” refers to polyethylene wax, and “C1” refers to the polyester-polyether copolymer of Preparative Example 1.

As shown in Table 2, the polyester sheet of CE4, which is made from the polyester composition free of the slip agent, exhibits unsatisfactory cutting property. The polyester sheet of CE5, which is made from the polyester composition including the slip agent in an amount of greater than 0.5 part by weight, exhibits a low transparency and an unsatisfactory printability. The polyester sheet of CE6, which is made from the polyester composition including the slip agent having a solubility of 16.2 MPa^{1/2}, exhibits a relatively low transparency and an unsatisfactory printability.

In comparison, the polyester sheets of EX3 and EX4, each of which is made from the polyester composition including the anti-blocking agent, the slip agent, and the polyester-polyether copolymer, with the slip agents having a solubility parameter within the range of 17 MPa^{1/2} to 22 MPa^{1/2} and is present in an amount within the range of 0.02 part by weight to 0.5 part by weight, exhibit satisfactory cutting property, printability and transparency, and have an improved cold impact resistance.

TABLE 3

| | | | EX | CE | | | |
|---|---|---|---|---|---|---|---|
| Polyester sheet (Total thickness: 3 mm) | | | 1 | 1 | 7 | 8 | 9 |
| Modified | Thickness (mm) | | 0.036 | 0.036 | 0.036 | 0.036 | 0.036 |
| layers | PET | Amount | 100 | 100 | 100 | 100 | 100 |
| | | (parts by weight) | | | | | |
| | Anti-blocking | Type | A1 | — | A1 | A1 | A1 |
| | agent | Amount | 0.35 | — | 0.35 | 0.35 | 0.35 |
| | | (parts by weight) | | | | | |
| | Slip agent | Type | B1 | — | B1 | B1 | B1 |
| | | Amount | 0.075 | — | 0.075 | 0.075 | 0.075 |
| | | (parts by weight) | | | | | |
| | Copolymer | Type | C1 | — | — | C1 | C2 |
| | | Amount | 2 | — | — | 6 | 2 |
| | | (parts by weight) | | | | | |
| Property | Cutting property | Room temperature | ⊚ | X | ⊚ | ◯ | ⊚ |
| evaluations | | Low temperature | ◯ | X | X | X | X |
| | Printability | Surface tension | 36 | 38 | 36 | 38 | 34 |
| | | (dyne/cm) | | | | | |
| | Cold impact | Percentage of | 40 | 90 | 62 | 35 | 35 |
| | resistance | breakage (%) | | | | | |
| | Transparency | Haze (%) | 3.4 | 1.6 | 3.1 | 5.4 | 7.1 |

“—” means not applicable, “A1” refers to a cross-linked methyl methacrylate-styrene copolymer, “B1”
refers to stearyl erucamide, “C1” refers to the polyester-polyether copolymer of Preparative Example
1, and “C2” refers to styrene-butadiene copolymer.

As shown in Table 3, the polyester sheet of CE7, which is made from the polyester composition free of the polyester-polyether copolymer, exhibits an unsatisfactory cutting property under low temperature, and a relatively low cold impact resistance. The polyester sheet of CE8, which is made from the polyester composition including the polyester-polyether copolymer in an amount of greater than 5 parts by weight, exhibits a relatively low transparency and an unsatisfactory cutting property under low temperature. The polyester sheet of CE9, which is made from the polyester composition including a styrene-butadiene copolymer instead of the polyester-polyether copolymer, exhibits a relatively low transparency, and unsatisfactory printability and cutting property under low temperature.

In comparison, the polyester sheet of EX1, which is made from the polyester composition including the anti-blocking agent, the slip agent, and the polyester-polyether copolymer, with the anti-blocking agent present in an amount within the range of 0.05 part by weight to 0.6 part by weight, exhibits satisfactory cutting property, printability and transparency, and have an improved cold impact resistance.

In sum, by including the anti-blocking agent, the slip agent which has a solubility parameter ranging from 17 MPa^{1/2} to 22 MPa^{1/2}, and the polyester-polyether copolymer, and by controlling the amounts of these components to be within the particular ranges, the polyester composition of this disclosure is capable of making a polyester sheet that exhibits a satisfactory cutting property under room temperature and low temperature, a relatively high transparency, a relatively high cold impact resistance, and a satisfactory printability.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A polyester sheet, comprising:
at least one modified layer made from a polyester composition including
a polyester;
a polyester-polyether copolymer;
a slip agent which has a solubility parameter ranging from 17 MPa^{1/2} to 22 MPa^{1/2}; and
an anti-blocking agent;
wherein
based on 100 parts by weight of said polyester, said polyester-polyether copolymer is present in an amount ranging from 0.5 part by weight to 5 parts by weight, said slip agent is present in an amount ranging from 0.02 part by weight to 0.5 part by weight, and said anti-blocking agent is present in an amount ranging from 0.05 part by weight to 0.6 part by weight.

2. The polyester sheet according to claim 1, comprising two of said modified layers and further comprising a middle layer which includes a polyester, and which is sandwiched between said modified layers.

3. The polyester sheet according to claim 1, wherein said polyester-polyether copolymer of said polyester composition includes a polyester segment and a polyether segment, and said polyether segment is present in an amount ranging from 5 wt % to 60 wt % based on a total weight of said polyester-polyether copolymer.

4. The polyester sheet according to claim 1, wherein said polyester-polyether copolymer of said polyester composition includes a polyester segment and a polyether segment, and said polyether segment is a poly(tetramethylene ether) glycol segment.

5. The polyester sheet according to claim 1, wherein said slip agent of said polyester composition is an amide-containing compound.

6. The polyester sheet according to claim 5, wherein said slip agent is selected from the group consisting of stearamide, stearyl erucamide, ethylene bis(erucamide), and combinations thereof.

7. The polyester sheet according to claim 1, wherein said anti-blocking agent of said polyester composition includes inorganic particles selected from the group consisting of silicon dioxide, calcium carbonate, aluminum silicate, barium sulfate, calcium phosphate, talcum, titanium dioxide, aluminum oxide, calcium silicate, and combinations thereof.

8. The polyester sheet according to claim 1, wherein said anti-blocking agent of said polyester composition includes organic particles selected from the group consisting of a cross-linked methyl methacrylate-styrene copolymer, a cross-linked styrene copolymer, a cross-linked methyl methacrylate copolymer, and combinations thereof.

9. The polyester sheet according to claim 1, wherein said anti-blocking agent of said polyester composition has an average particle size ranging from 1 μm to 30 μm.
